(19) United States
(12) Patent Application Publication
(10) Pub. No.: US 2009/0001823 A1
(43) Pub. Date: Jan. 1, 2009

(54) Magnet Assembly for a Linear Electromechanical Machine

(75) Inventors: Stephen Charles Welty, Cambridge (GB); Jarlath Michael McEntee, Castine, ME (US); Stephen John Williams, Bromsgrove (GB)

Correspondence Address: Ballard Spahr Andrews & Ingersoll, LLP, SUITE 1000, 999 PEACHTREE STREET, ATLANTA, GA, 30309-3915, US

(73) Assignee: Microgen Energy Limited, Reading (GB)

(21) Appl. No.: 11/665,324

(22) PCT Filed: Oct. 14, 2005
(86) PCT No.: PCT/GB2005/003982

§ 371 Date: Aug. 12, 2008

(30) Foreign Application Priority Data
Oct. 15, 2004 (GB) 0422996.9
Apr. 12, 2005 (GB) 0507385.3

(51) Int. Cl. H02K 35/00; H01F 3/08

(52) U.S. Cl. 310/28; 29/608

(57) ABSTRACT

A magnetic assembly for a linear electromechanical machine, the assembly comprising an annular support centered on an axis of reciprocation of the machine. A magnet assembly is attached to the annular support. The magnet assembly comprises at least one annular part which is substantially magnetic. The annular part has at least one non-conductive portion in a substantially radial plane and extending at least half of the way through the wall of the annulus.

The present invention relates to a magnet assembly for a linear electromechanical machine and to a method of forming a magnet. In particular, the invention relates to a magnet assembly for a linear motor or alternator.

As is well known in the art, in an alternator, the movement of a magnet in the vicinity of an electrical conductor induces an electrical current in the conductor. In the case of a motor, the varying current through the conductor causes a varying magnetic field in the magnet causing motion of the magnet.

The present invention relates to an improved design of magnet assembly for use in such a machine. The invention has been designed for a linear Stirling engine and, more particularly, for a linear free piston Stirling engine. However, as mentioned above, it can be applied broadly to linear electromechanical machines.

WO97/13261 discloses a magnet assembly for a linear electromechanical machine. In particular, the support structure is provided in the form of an annular drum which has a plurality of slots extending in the direction of reciprocation. Mounted on the drum are a plurality of magnets. Typically, the number of magnets is equal to the number of slots. The slotted drum and the plurality of magnetic segments are designed to reduce losses caused by eddy current in the drum and magnets.

The present invention aims to improve on the magnet assembly of WO97/13261 and to produce a magnet assembly of comparable efficiency, but which can be manufactured at a considerably reduced cost, and which is suitable for mass production assembly.

According to a first aspect of the present invention, there is provided a magnetic assembly for a linear electromechanical machine, the assembly comprising an annular support centred on an axis of reciprocation of the machine, a magnet assembly attached to the annular support, the magnet assembly comprising at least one annular part which is substantially magnetic and is centred on the axis of reciprocation, wherein the at least one annular part has at least one non-conductive portion in a substantially radial plane and extending at least half of the way through the wall of the annulus.

The non-conductive portion serves to limit the eddy currents. The use of the annular part greatly facilitates the manufacturing process. In WO97/13261 there are typically ten magnet segments. Each of these has to be separately attached to the drum. Not only that, but each segment has to be placed at the correct circumferential location so as to be correctly aligned with the adjacent segments and the slots in the drum.

By contrast, the annular part of the present invention is simple to mount as the number of separate components is greatly reduced. The circumferential alignment of the magnet and drum is not an issue as the magnet can be mounted in any circumferential orientation.

In its simplest form, the non-conductive portion is formed by a slit. Effectively the non-conductive portion is then provided by an air gap. This is simple to manufacture and creates a light weight magnet. However, the presence of one or more slits reduces the strength of the magnet. Therefore, if greater strength is required to enable the magnet to retain its form during extended operation, the non-conductive portion may be of a solid non-conductive material.

The magnetic assembly may be used either for a reciprocating part of the machine, or for a static part. In the first case, the annular support is a drum arranged, in use, to reciprocate along the axis of reciprocation. In the latter case, the annular support is fixed and a core is reciprocated with respect to the drum, to induce a magnetic field in the core.

The invention may be carried out with a single annular part. However, preferably, there are a plurality of such annular parts arranged axially. Although this increases the number of components, it is still considerably less than the number of components of WO97/13261 and the problems of circumferential alignment still do not arise.

There are a number of potential configurations of non-conductive portions which can be employed. For example, the non-conductive portion may extend from an axially facing end face of the magnet, or may extend from a radially facing face.

A single non-conductive portion has been found to provide a significant reduction in eddy currents. In order to create a more tortuous path-around the magnet, two spaced non-conductive portions may be provided. In this case, each would extend from an opposite face of the magnet. In the case of two non-conductive portions, these should be staggered and overlap so that any circle within the magnet and centred on the axis of reciprocation will intersect at least one portion. In other words, there is no uninterrupted circumferential path around the magnet.

Preferably, each non-conductive portion extends across more than 75% of the magnet, and possibly across as much as 90% of the magnet. The greater the extent of the non-conductive portion, the better the reduction in eddy currents.

Alternatively, the non-conductive portions may extend fully across the magnet. In the case of the slit, there will only be one such non-conductive portion extending fully across the magnet. However, for the solid non-conductive portion there may be a plurality of such portions.

The non-conductive portion may be a separate component inserted into a slot in the annular part. However, preferably, the non-conductive component is integrally formed with the annular part. This is the subject of the second aspect of the invention.

According to the second aspect of the present invention there is preferably provided a method of forming an annular magnet using an annular mould having a central axis and a plurality of feed nozzles, the nozzles being arranged in a circle about the central axis and corresponding to the annular mould and being movable in the direction of the central axis, at least one nozzle containing powdered non-conductive material and the remaining nozzles containing powdered magnetic material, the method comprising lowering the nozzles into the mould, depositing powdered material, raising the nozzles as the material is dispensed to fill the mould, removing the nozzles, compacting and heating the powdered material to form a single ring, and exposing the material to a magnetic field to create magnetic poles.

This method provides a simple way of manufacturing a composite core in a single operation.

The magnetic field may either be applied before or after the material is compacted and heated, but is preferably applied on both occasions.

An example of a magnet assembly in accordance with the present invention will now be described with reference to the accompanying drawings, in which:

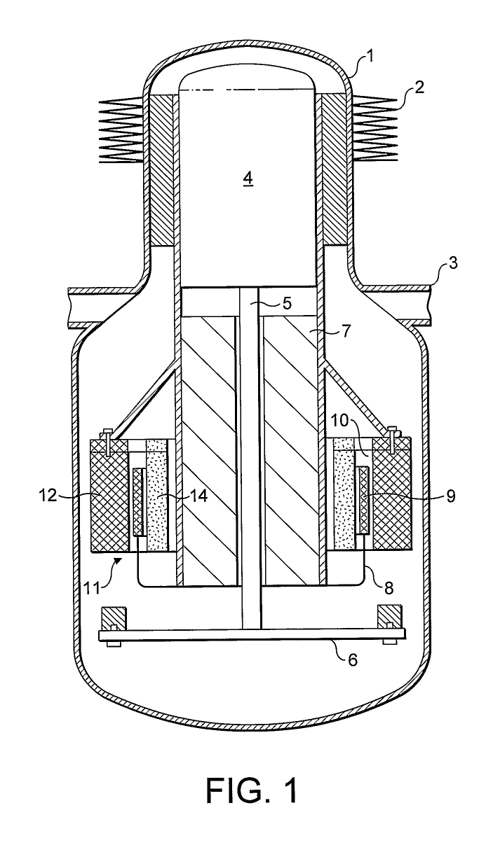

FIG. 1 is a schematic cross section of a linear free piston Stirling engine to which the present invention may be applied;

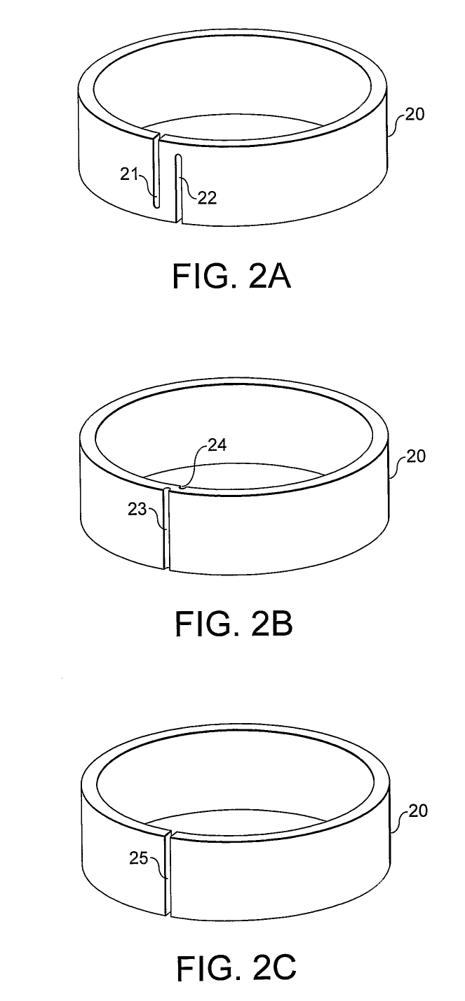

FIGS. 2A-2C illustrate various configurations of magnets suitable for use with the invention;

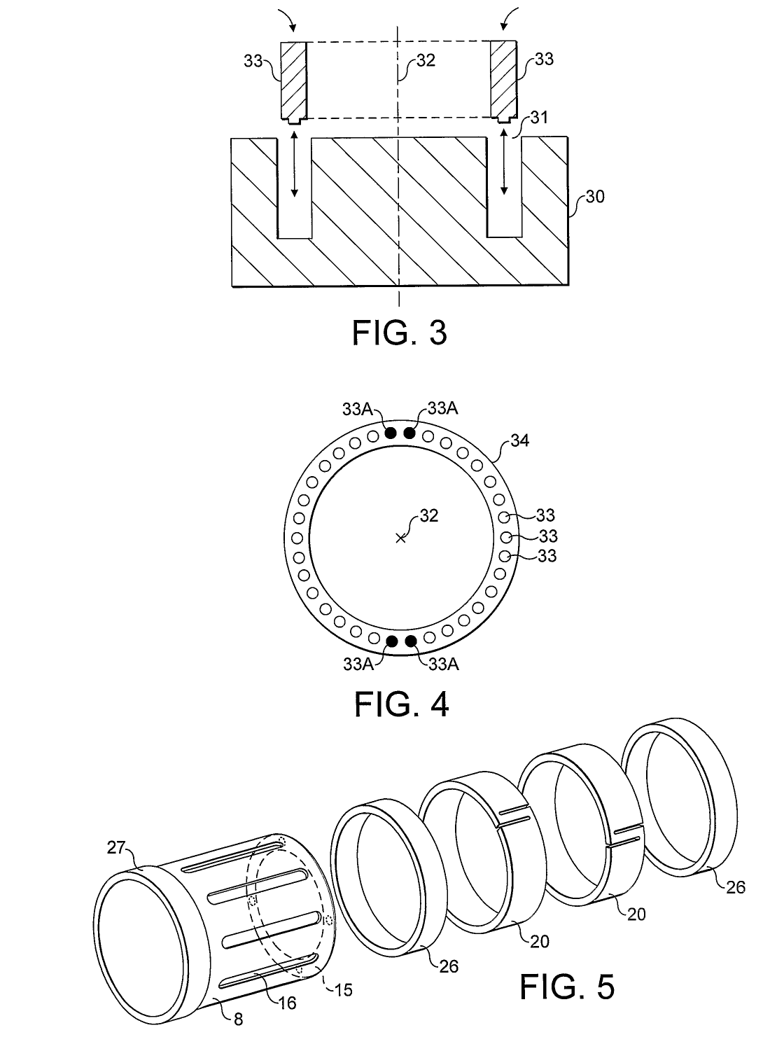

FIG. 3 is a schematic cross section of a mould and nozzles for making a magnet according to the second aspect of the invention;

FIG. 4 is a schematic plan view showing the layout of the nozzles as shown in FIG. 3; and

FIG. 5 is an exploded cross section showing the assembly of the magnet and drum.

FIG. 1 shows the basic components of a linear free piston Stirling engine to which the present invention may be applied. The Stirling engine comprises a head 1 provided with a plurality of fins 2 which are heated by an external burner. A cooling circuit 3 is provided to remove heat from an intermediate portion of the engine. A displacer 4 is positioned in the head of the engine and is attached to a flexible rod 5 which extends axially down through the engine and is attached to at least one plate spring 6 which is fixed to the engine casing. The displacer 4 is thus mounted to reciprocate in the axial direction. Surrounding the rod 5 is a power piston 7 which is also supported to reciprocate in the engine out of phase with the displacer 4. An annular drum 8 is attached to the power piston 7 and is provided with a magnet assembly 9 described in greater detail below.

The magnet assembly 9 is arranged to reciprocate axially in an air gap 10 in a stator 11. The stator 11 comprises an outer annular winding and laminate assembly 12 and an inner core 14 of a ferromagnetic material (e.g. a soft magnetic composite). This is not a permanently magnetised component, but can still be provided with longitudinal slits (which may be filled with non-conductive material or left empty) to reduce eddy currents which are induced during normal operation. The magnet assemblies 9 and 14 are made of a standard permanent magnet material such as iron neodymium. The operation of the linear free piston is well known in the art.

The present invention is concerned with an improved design of the annular magnet assembly 9 on the drum 8. Various alternative designs of magnets are shown in FIGS. 2A-2C.

FIG. 2A shows an annular magnet 20 having a first axial slot 21 extending from an axial end face some three quarters of the way down the magnet. A second slot 22 is cut into the opposite axial face and extends a similar distance across the magnet 20.

In FIG. 2B the axial slots are replaced with slots 23, 24 in two opposite circumferential faces of the magnet 20.

In FIG. 2C a single slit 25 is provided through the full width of the magnet 20 effectively providing a split ring configuration.

It will be appreciated that a number of variations on these designs are possible. For example in FIGS. 2A and 2B only one of the two slots may be required. Alternatively more than two slots may be provided, and there may be numerous slots extending around the circumference of the magnet. Further, the configurations of the slots may be mixed, such that there are slots from two or even three of the examples combined on a single magnet.

It will be appreciated that the exact configuration of slots will be determined in accordance with the performance requirements. These present a trade off between the reduction of eddy currents on the one hand and the ease of handling of the magnets and manufacturing costs on the other. A single slot, for example the slot 21 shown in FIG. 2A will provide a magnet which is simple to handle and provide some significant reduction in eddy currents. To reduce the eddy currents further the plurality of staggered slot arrangements of FIG. 2A or 2B could be provided together with the split ring configuration of FIG. 2C. However, this would be more expensive to manufacture and more difficult to handle.

FIGS. 2A to 2C have been described with reference to a non-conductive material being a slit. However, the illustrated configurations are equally applicable to the non-conductive material being solid. In this case, the region occupied by the slit will, instead, be filled with non-conductive material. FIG. 2C shows a single slit extending through the full width of the magnet. Only one such slit can be provided, otherwise the magnet becomes two components. However, when a solid non-conductive material is used, this non-conductive material can extend across the full width of the magnet in more than one location while maintaining the component as a single annular component.

In order to form an annular ring with a solid non-conductive material insert, it will be possible to fill the slit of FIGS. 2A to 2C with appropriate material. However, the current preference is to form the annular magnet with its solid non-conductive portion in a single manufacturing process which will now be described with reference to FIGS. 3 and 4.

The preferred solid non-conductive material is ceramic powder or a thermoplastic.

The illustrated arrangement is designed to produce two regions of non-conductive material which extend fully across the width of the magnet.

The apparatus comprises a mould 30 with an annular recess 31 centred around main axis 32. Above the annular recess 31 are nozzles 33 arranged about the main axis 32 and mounted on a nozzle ring 34. The nozzles are moveable along axis 32 into and out of the annular recess 31. The majority of the nozzles 33 are filled with a powdered magnetic material. However, two of the nozzles 33A on either side are filled with a non-conductive material.

With the nozzles in the annular recess 31 and positioned with their outlets close to the bottom of the recess, powder is fed into the top of the nozzle ring using a gravity feed to allow injection of the powder into the lower area of the recess. A low velocity gas feed arrangement could be used as an alternative to the gravity feed.

A magnetic field is applied to the mould during the feed process to ensure the correct alignment of the magnetic particles during the filling process. The nozzle ring 34 is raised gradually with the minimum of agitation to prevent mixing of the different feed materials.

Once the mould is filled, the nozzle ring 34 is removed and so is the magnetic field. A solid compacting ring (not shown) is lowered gently into the mould to compact the mixture. The mould is situated within a furnace and, at this point, the furnace is brought up to its operating temperature without moving the mould. This sinters the material within the mould to form a single ring of the two materials. The ring is removed from the mould and cooled and is then subjected to a further magnetic field to reinforce the magnetic pattern and to allow the correct number of magnetic poles to be created.

FIG. 5 shows the construction of the magnet drum 8 and the magnet assembly 9 in greater detail. The drum 8 is provided with a flange 15 at its lowermost end allowing it to be mounted to the power piston 7. The drum has an annular configuration and is provided with a plurality of axially extending slots 16 in accordance with the teaching of WO97/13261. It should be noted that the slots 10 can also extend in an oblique direction. The magnet assembly comprises four annular magnets, namely two main magnets 20 and two spring magnets 26. The main magnets 20 may be configured according to any of FIGS. 2A to 2C above, or any of the alternatives discussed in relation to these figures. The spring magnets 26 are annular magnets of opposite polarity to the main magnets and are provided to generate a restoring force on the power piston 7 should its travel approach certain pre-set limits. Such spring magnets are well known in the art.

The magnets 20, 26 are placed over the drum with the spring magnet 26 locating against an annular lip 27 providing radial stiffness to the drum and are fixed in place with adhesive. The drum is then bolted to the lower end of the power piston 7 and the magnets 9 are inserted into the air gap 10.

1. A magnetic assembly for a linear electromechanical machine, the assembly comprising an annular support centred on an axis of reciprocation of the machine, a magnet assembly attached to the annular support, the magnet assembly comprising at least one annular part which is substantially magnetic and is centred on the axis of reciprocation, wherein the at least one annular part has at least one non-conductive portion in a substantially radial plane and extending at least half of the way through the wall of the annulus.

2. An assembly according to claim 1, wherein the non-conductive portion is a slit.

3. An assembly according to claim 1, wherein the non-conductive portion is a solid non-conductive material.

4. An assembly according to claim 3, wherein the non-conductive portion is integrally formed with the annular part.

5. An assembly according to claim 3, wherein the non-conductive portion is a component inserted into a slot in the annular part.

6. An assembly according to any one of the preceding claims, wherein the annular support is a drum arranged, in use, to reciprocate along the axis of reciprocation.

7. An assembly according to any one of claims 1 to 5, the assembly being a stator, wherein the annular support is fixed with respect to a reciprocated component.

8. An assembly according to any one of the preceding claims, wherein the non-conductive portion extends from an axially facing face of the magnet.

9. An assembly according to any one of claims 1 to 7, wherein the non-conductive portion extends from a radially facing face of the magnet.

10. An assembly according to any one of the preceding claims comprising two non-conductive portions, each extending from opposite faces of the magnet.

11. An assembly according to any one of the preceding claims, wherein the or each non-conductive portion extends across at least 75% of the part.

12. An assembly according to claim 11, wherein the or each non-conductive portion extends across substantially 90% of the part.

13. An assembly according to claim 2, wherein the slit extends fully across the part.

14. An assembly according to any one of claims 3 to 5, wherein the or each non-conductive portion extends fully across the part.

15. A method of forming an annular magnet using an annular mould having a central axis and a plurality of feed nozzles, the nozzles being arranged in a circle about the central axis and corresponding to the annular mould and being movable in the direction of the central axis, at least one nozzle containing powdered non-conductive material and the remaining nozzles containing powdered magnetic material, the method comprising lowering the nozzles into the mould, dispensing powdered material into the mould, raising the nozzles as the material is dispensed to fill the mould, removing the nozzles, compacting and heating the powdered material to form a single ring, and exposing the material to a magnetic field to create magnetic poles.

16. A method according to claim 15, wherein the material is exposed to a magnetic field before the material is compacted and heated.

17. A method according to claim 15 or claim 16, wherein the material is exposed to a magnetic field after the material is compacted and heated.
